(19) United States
(12) Patent Application Publication
(10) Pub. No.: US 2019/0240919 A1
(43) Pub. Date: Aug. 8, 2019

(54) Method for Welding a Polyolefin Plastic and an Additional Plastic

(71) Applicant: Henkel AG & Co. KGaA, Duesseldorf (DE)

(72) Inventors: Hendrik Luetzen, Muenchen (DE); Pablo Walter, Muenchen (DE); Thomas Haertig, Muenchen (DE); Dirk Kasper, Duesseldorf (DE); Christian Klug, Duesseldorf (DE)

(21) Appl. No.: 16/385,147

(22) Filed: Apr. 16, 2019

Related U.S. Application Data
(63) Continuation of application No. PCT/EP2017/077306, filed on Oct. 25, 2017.

(30) Foreign Application Priority Data
Oct. 28, 2016 (EP) 16196228.7

(51) Int. Cl. B29C 65/00; B29C 65/20; B29C 65/08; B29C 65/14

(52) U.S. Cl. CPC B29C 66/026; B29C 65/20; B29K 2701/12; B29C 65/1412; B29C 66/712; B29C 65/08

(57) ABSTRACT

The invention relates to a method for welding a polyolefin plastic and a plastic using a primer, said primer containing at least one maleic anhydride containing polymer and at least one polyester. The invention also relates to correspondingly bonded products.

The present invention relates to a method for welding a polyolefin plastics material to a plastics material using a primer, the primer containing at least one polymer that contains maleic acid anhydride, and at least one polyester. The present invention also relates to products welded in this manner.

Various methods are known in the art for interconnecting two or more substrates made of plastics materials, such as polyethylene (PE), polyacrylates or polyamide (PA). This involves both mechanical connection options, such as latching or screwing, or bonding methods. Alternatively, plastics materials can also be welded together. Welding is a joining method for a non-detachable, material physical connection of plastics materials that are generally of the same type, such as PE to PE or PA to PA. Thermoplastic materials of the same type are those polymers which do not substantially differ in terms of molecular structure, melting point, melting viscosity and heat expansion coefficient, and can in principle be mixed together to an extent. Plastics materials of the same type are plastics materials that have an identical polymer base or are identical plastics materials.

A wide range of methods are known for welding together two or more plastics materials of the same type. A wide range of welding methods can be used in this case, such as infrared welding, infrared/vibration welding or ultrasonic welding. These methods for welding plastics materials of the same type are based on the respective plastics materials being melted in the region of the welding zone, and the substances in this zone being integrally and frictionally bonded to one another.

These welding methods are effective insofar as plastics materials of the same type are intended to be interconnected. If, however, two plastics materials are intended to be welded together which are not of the same type, or which are incompatible with one another, for example plastics materials made of polypropylene and polycarbonate, a permanent connection having high mechanical strength between the two substrates is not possible. If attempts are made to directly weld the two plastics materials polypropylene and polycarbonate or the two plastics materials propylene and ABS (acrylonitrile butadiene styrene copolymer) or the two plastics materials polypropylene and PET (polyethylene terephthalate) or the two plastics materials polypropylene and PBT (polybutylene terephthalate) using the welding method known from the prior art, very little to no strength is achieved.

Until now, plastics materials which differ accordingly could be interconnected only by a mechanical connection or a bonding process. The drawbacks of a mechanical connection are complicated attachment, material strain at certain points and also the requirement for an additional mechanical connection means. In addition, integral bonding can rarely be achieved in the case of a mechanical connection. The disadvantage of a bonding process is, however, that the final strength of the bond is achieved only after a long period of time, which can be up to several weeks. In addition, bonding low-energy surfaces often requires complex pre-treatment of the joining parts. A bonded connection is also often not infinitely stable on account of external atmospheric conditions. Providing a neat bonded connection is also often complicated and time-consuming. The connection by means of a method for welding plastics materials thus represents the neatest, quickest and simplest solution.

The problem addressed by the present invention was therefore that of finding a simple method for welding a polyolefin plastics material to a second plastics material. The connection between these different plastics materials should be permanent and as stable as possible as a result of the weld.

Surprisingly, it was found that this problem is solved by a method for welding a polyolefin plastics material to a second plastics material using a primer, the primer containing at least one polymer that contains maleic acid anhydride, in particular at least one maleic acid anhydride-grafted polyolefin polymer, and at least one polyester, in particular at least one copolyester.

By using a primer containing at least one polymer that contains maleic acid anhydride, in particular at least one maleic acid anhydride-grafted polyolefin polymer, and at least one polyester, preferably at least one copolyester, particularly stable integral bonding could be achieved between the plastics materials when welding a polyolefin plastics material to a plastics material.

The first joining part for welding using a primer is a polyolefin plastics material, in particular a thermoplastic polyolefin plastics material. A polyolefin plastics material is based on polyolefinic polymers, such as homopolymers and copolymers of alpha-olefins. The polyolefinic polymers can be selected from the group consisting of poly-alpha-olefin homopolymers based on ethylene, propylene and/or butylene, in particular ethylene homopolymers or propylene homopolymers, and poly-alpha-olefin copolymers based on ethene, propene, 1-butene, 1-hexene and 1-octene, in particular ethylene/alpha-olefin and propylene/alpha-olefin copolymers, preferably copolymers of ethene or propene having 1-butene, 1-hexene, 1-octene or a combination thereof. In particular, the polyolefin plastics materials are preferably selected from polyethylene (in particular high-density (HD) polyethylene, medium-density (MD) polyethylene, low-density (LD) polyethylene, ultra-high-molecular-weight (UHMW) polyethylene and linear low-density (LLD) polyethylene, preferably HD polyethylene, MD polyethylene or LD polyethylene) and polypropylene plastics materials. The polyolefin plastics material is particularly preferably a polyethylene plastics material or polypropylene plastics material, particularly preferably a polypropylene plastics material.

The polyolefin polymers, in particular polypropylene polymers, preferably have a weight-average molar mass (weight average Mw) of greater than 10,000 g/mol, in particular greater than 20,000 g/mol preferably greater than 50,000 g/mol, particularly preferably greater than 100,000 g/mol. The polyolefin polymers, in particular polypropylene polymers, preferably have a weight-average molar mass (weight average Mw) of less than 2,000,000 g/mol, in particular less than 1,000,000 g/mol, preferably less than 500,000 g/mol. Particularly preferred polyethylene polymers have a weigh-average molar mass (weight average Mw) of from 50,000 g/mol to 1,000,000 g/mol, in particular from 200,000 g/mol to 500,000 g/mol. Other preferred polyethylene polymers (UHMW PE polymers) have a weight-average molar mass of greater than 2,000,000 g/mol, in particular from 4,000,000 g/mol to 6,000,000 g/mol. Particularly preferred polyolefin polymers, in particular polypropylene polymers, have a weight-average molar mass (weight average Mw) of from 50,000 g/mol to 250,000 g/mol.

The polyolefin plastics materials, in particular polypropylene plastics materials, can also contain further components, e.g. fillers, such as natural or glass fibers, pigments, dyes, rheological aids, demolding aids or stabilizers. The polyolefin plastics material, in particular polyethylene plastics material and/or polypropylene plastics material, preferably polypropylene plastics material, particularly preferably consists of the specified polyolefin polymers, in particular the specified polyethylene polymers and/or polypropylene polymers, preferably polypropylene polymers, in an amount of greater than 80 wt. %, in particular greater than 90 wt. %, preferably greater than 98 wt. %, in each case based on the polymer proportion of the polyolefin plastics material (total polyolefin plastics material without fillers). The polyolefin plastics material, preferably polypropylene plastics material, preferably consists of the specified polyolefin polymer, in particular polypropylene, in an amount of greater than 50 wt. %, in particular greater than 70 wt. %, preferably greater than 90 wt. %, more preferably greater than 95 wt. %, particularly preferably greater than 98 wt. %, in each based on the total polyolefin plastics material (with fillers). A further preferred polyolefin plastics material, in particular polyethylene and/or polypropylene plastics material, preferably polypropylene plastics material, consists of the specified polyolefin polymers, in particular the specified polyethylene and/or polypropylene polymers, preferably polypropylene polymers, in an amount of from 10 to 80 wt. %, in particular from 30 to 50 wt. %, in each case based on the total polyolefin plastics material (with fillers). This is particularly preferred for polyolefin plastics materials which are filled with natural fibers. A preferred polyolefin plastics material, in particular polyethylene and/or polypropylene plastics material, preferably polypropylene plastics material, contains 20 to 80 wt. %, in particular 50 to 70 wt. % fibers, in particular natural fibers, based on the total polyolefin plastics material (with fillers).

The second joining part for welding using a primer is a further plastics material. The plastics materials to be joined, or the polymers on which said plastics materials are based, can be selected from the following: Polyoxyalkylenes, polycarbonates (PC), polyesters such as polybutylene terephthalate (PBT) or polyethylene terephthalate (PET), polyolefins such as polyethylene or polypropylene, poly(meth)acrylates, polyamides, vinyl aromatic (co)polymers such as polystyrene, impact-modified polystyrene such as HIPS, or SAN, ASA, ABS or AES polymers, polyarylene ethers such as polyphenylene ethers (PPE), polysulfones, polyphenylene sulfides (PPS), polyurethanes, polylactides, halogen-containing polymers, such as polyvinyl chloride (PVC), imide group-containing polymers, cellulose esters, silicone polymers and thermoplastic elastomers. Mixtures of different thermoplastic polymers can also be used as materials for the plastics molded parts. Said mixtures may be single-phase or multiphase polymer blends. The molded parts to be interconnected may consist of identical or different thermoplastic polymers or thermoplastic polymer blends; the plastics materials preferably comprise a thermoplastic polymer as a main component, in particular consisting of said thermoplastic polymer in amount of greater than 30 wt. %, in particular greater than 60 wt. %, preferably greater than 70 wt. %, more preferably greater than 90 wt. %, particularly preferably greater than 95 wt. %, in each case based on the polymer proportion of the plastics material, in particular in each case based on the total plastics material (with fillers).

Preferably, the second plastics material is selected from plastics materials from polycarbonate (PC), acrylonitrile butadiene styrene (ABS), polymethyl methacrylate (PMMA), polyethylene terephthalate (PET), polybutylene terephthalate (PBT), polystyrene (PS), polystyrene acrylonitrile (SAN), polyacrylic ester styrene acrylonitrile (ASA), methyl methacrylate acrylonitrile butadiene styrene (MABS), high impact polystyrene (HIPS), polyamide (PA) or mixtures thereof. The mixtures, also known as blends, are mixtures of the specified plastics materials or the corresponding polymers, insofar as this is possible. An example would be an ABS/PC plastics material. In a preferred embodiment, the second joining part consists of a plastics material which differs from the plastics material of the first joining part in terms of composition and/or properties. It is therefore preferable for the second plastics material to differ from the first polyolefin plastics material. In particular, the second plastics material is not a polyethylene or polypropylene plastics material, preferably not a polyolefin plastics material.

Polyamide plastics materials are suitable as the second plastics materials to be joined, for example. The polyamide plastics material is preferably a thermoplastic polyamide. The amide-based thermoplastic polymers include, for example: polyamide 6, a homopolymer of epsilon-caprolactam (polycaprolactam); polyamide 11, a polycondensate of 11-aminoundecanoic acid (poly-11-aminoundecanoic amide); polyamide 12, a homopolymer of omega-laurolactam (polylaurolactam); polyamide 6.6, a homopolycondensate of hexamethylenediamine and adipic acid (polyhexamethylene adipamide); polyamide 6.10, a homopolycondensate of hexamethylenediamine and sebacic acid (polyhexamethylene sebacamide); polyamide 6.12, a homopolycondensate of hexamethylenediamine and dodecanedioic acid (polyhexamethylene dodecanamide) or polyamide 6-3-T, a homopolycondensate of trimethylhexamethylenediamine and terephthalic acid (polytrimethyl hexamthylene terephthalic amide), polyp-phenylene-terephthalic amide) or poly(m-phenylene terephthalic amide) of phenylene diamine and terephthalic acid, polyphthalamides PPA of different diamines and terephthalic acid and mixtures thereof.

Optically transparent polyamides comprise microcrystalline polyamides containing linear aliphatic dicarboxylic acids and cycloaliphatic diamines, amorphous polyamides containing linear aliphatic dicarboxylic acids and cycloaliphatic diamines and optionally lactams or amino carboxylic acids, amorphous polyamides containing terephthalic acid and cycloaliphatic or branched aliphatic diamines and optionally lactams or amino carboxylic acids or amorphous polyamides containing isophthalic acid and cycloaliphatic or linear or branched aliphatic diamines and optionally lactams or amino carboxylic acids. Suitable optically transparent polyamides are, for example, amides of dodecanedioic acid and an isomer mixture of 4,4′-bis(aminocyclohexyl)methane, of terephthalic acid and the isomer mixture of 2,2,4- and 2,4,4-trimethylhexamethylenediamine, of dodecanedioic acid and the isomer mixture of 3,3′-dimethyl-4,4′-bis(aminocyclohexyl)methane, of laurolactam, isophthalic acid and the isomer mixture of 3,3′-dimethyl-4,4′-bis(aminocyclohexyl)methane or of tetradecanedioic acid and the isomer mixture of 3,3′-dimethyl-4,4′-bis(aminocyclohexyl)methane or of epsilon-caprolactam or omega-laurolactam.

Preferred polyamides are selected from the group consisting of polyamide 6, polyamide 6.6, polyamide 6.10, polyamide 6.12, polyamide 10.10, polyamide 11, polyamide 12, polyamide 10.12, polyphthalamides, optically transparent polyamides or mixtures based on said polyamides. Particularly preferred polyamides are selected from polyamide 6, polyamide 6.6, polyamide 12, polyphthalamides, optically transparent polyamides and mixtures thereof, in particular polyamide 6, polyamide 6.6 and mixtures thereof.

Polyoxyalkylene homopolymers or copolymers, in particular (co)polyoxymethylenes (POM) are also suitable for producing the plastics materials. Very generally, said polymers have at least 50 mol % of repeated —CH20 units in the polymer main chain. Homopolymers are generally produced by polymerization of formaldehyde or trioxane, preferably in the presence of suitable catalysts. Polyoxymethylene copolymers and polyoxymethylene terpolymers are preferred. The preferred polyoxymethylene (co)polymers have melting points of at least 150° C. and weight-average molar masses (weight average) Mw in the range of from 5,000 to 200,000, preferably from 7,000 to 150,000 g/mol. End-group-stabilized polyoxymethylene polymers which have C—C bonds at the chain ends are particularly preferred. In a further embodiment, in particular hydroxyl-group-terminated polyoxymethylene polymers.

Polyarylene ethers are understood to be preferably polyarylene ethers per se, polyarylene ether sulfides, polyarylene ether sulfones or polyarylene ether ketones. The arylene groups thereof may be the same or different and signify, independently of one another, an aromatic functional group having 6 to 18 carbon atoms. Examples of suitable arylene functional groups are phenylene, biphenylene, terphenylene, 1,5-napthylene, 1,6-napthylene, 1,5-anthrylene, 9,10-anthrylene or 2,6-anthrylene. Of these, 1,4-phenylene and 4,4′-biphenylene are preferred. Said aromatic functional groups are preferably not substituted. However, they can carry one or more substituents.

Preferably, the second plastics material may be a polyester plastics material. Suitable polyester plastics materials are likewise known per se and described in the literature. Preferred polyester plastics materials comprise a polyester having an aromatic ring, derived from an aromatic dicarboxylic acid, in the main chain. The aromatic ring can also be substituted, for example by halogen such as chlorine or bromine or by C1-C4 alkyl groups such as methyl, ethyl, i- or n-propyl groups or n-, i- or t-butyl groups. The polyesters can be prepared in a manner known per se by reacting aromatic dicarboxylic acids, the esters thereof or other ester-forming derivatives thereof with aliphatic dihydroxy compounds. Preferred dicarboxylic acids include naphthalene dicarboxylic acid, orthophthalic acid, terephthalic acid and isophthalic acid or mixtures thereof. Up to 30 mol % of the aromatic dicarboxylic acids can be replaced by aliphatic or cycloaliphatic dicarboxylic acids such as adipic acid, azelaic acid, sebacic acid, dodecanoic acid and cyclohexanedicarboxylic acid. Of the aliphatic dihydroxy compounds, diols having 2 to 8 carbon atoms, in particular 1,2-ethanediol, 1,4-butanediol, 1,6-hexanediol, 1,4-hexanediol, 1,4-cyclohexanedimethylol and neopentyl glycol or mixtures thereof are preferred. Particularly preferred polyesters include polyalkylene terephthalates which are derived from alkanediols having 2 to 6 carbon atoms.

The polyester plastics materials are preferably selected from the group of polyethylene terephthalate (PET), polyethylene naphthalate, polybutylene naphthalate and polybutylene terephthalate (PBT) plastics materials and mixtures thereof, in particular polyethylene terephthalate (PET) and polybutylene terephthalate (PBT) plastics materials and mixtures thereof.

The polyester plastics materials, in particular the polyethylene terephthalate (PET) polybutylene terephthalate (PBT) plastics materials, can also contain further components, e.g. fillers, such as glass fibers, pigments, mineral particles, dyes, rheological aids, demolding aids or stabilizers. The polyester plastics material preferably consists of the specified polyesters in an amount of greater than 40 wt. %, in particular greater than 60 wt. %, preferably greater than 70 wt. %, more preferably greater than 90 wt. %, in each based on the total polyester plastics material (with fillers). The polyester plastics material preferably consists of the specified polyesters in an amount of greater than 90 wt. %, in particular greater than 95 wt. %, preferably greater than 98 wt. %, in each based on the polymer proportion of the polyester plastics material (total plastics material without fillers). The polyester plastics materials preferably have a content of the specified polyesters, in particular polyethylene terephthalate and/or polybutylene terephthalate, of from 50-100 wt. %, in particular 90-100 wt. %, in each case based on the total polyester plastics material (with fillers).

In a preferred embodiment, the second plastics material is a polycarbonate plastics material. Polycarbonate plastics materials are preferably thermoplastic materials which can be formally described as polyesters of carbonic acid. Polycarbonates can in principle be prepared by polycondensation of phosgene with diols, preferably bisphenols. Preferred polycarbonates are aromatic polycarbonates. Aromatic polycarbonates are those which are composed of at least one aromatic monomer. Preferred polycarbonate plastics materials are plastics materials based on bisphenol, in particular bisphenol A and bisphenol F. For the bisphenol-based polycarbonates, the diol component consists of up to 50 wt. %, in particular up to 70 wt. %, preferably up to 90 wt. %, preferably up to 100 wt. % bisphenol, in particular bisphenol A and/or bisphenol F.

The polycarbonate plastics materials can also contain further components, e.g. fillers, such as glass fibers, pigments, mineral particles, dyes, rheological aids, demolding aids or stabilizers. The polycarbonate plastics material preferably consists of the specified polycarbonates in an amount of greater than 40 wt. %, in particular greater than 60 wt. %, preferably greater than 70 wt. %, more preferably greater than 90 wt. %, in each based on the total polycarbonate plastics material (with fillers). The polycarbonate plastics material preferably consists of the specified polycarbonates in an amount of greater than 90 wt. %, in particular greater than 95 wt. %, preferably greater than 98 wt. %, in each based on the polymer proportion of the polycarbonate plastics material (total plastics material without fillers). The polycarbonate plastics materials preferably have a content of the specified polycarbonates of from 50-100 wt. %, in particular 90-100 wt. %, in each case based on the total polycarbonate plastics material (with fillers).

In another preferred embodiment, the second plastics material contains at least one vinyl aromatic polymer, in particular copolymer, of monomers selected from styrene, chlorostyrene, alpha-methylstyrene and para-methylstyrene. In minor proportions, vinyl aromatic copolymers (preferably no more than 20 wt. %, in particular no more than 8 wt. %) and also comonomers such as (meth)acrylonitrile or (meth)acrylic acid ester, such as (methyl) methacrylate, can be part of the composition. Particularly preferred vinyl aromatic polymers are polystyrene, styrene acrylonitrile copolymers (SAN), polystyrene methyl methacrylate (SMMA) and impact-modified polystyrene (HIPS=High Impact Polystyrene). Of course, mixtures of said polymers can also be used.

Very particularly preferred vinyl aromatic polymers are MABS, SAN, ASA, ABS and AES polymers (MABS=(methyl) methacrylate acrylonitrile butadiene styrene, SAN=styrene acrylonitrile, ASA=acrylonitrile styrene acrylic ester, ABS=acrylonitrile butadiene styrene, AES=acrylonitrile EPDM rubber styrene). These impact-modified vinyl aromatic polymers contain at least one rubber-elastic graft polymer and one thermoplastic polymer (matrix polymer). A styrene/acrylonitrile polymer (SAN) is generally used as a matrix material. Graft polymers which contain a diene rubber based on dienes such as butadiene or isoprene (ABS), an alkyl acrylate rubber based on alkyl esters of acrylic acid such as n-butyl acrylate and 2-ethylhexyl acrylate, an EPDM rubber based on ethylene, propylene and a diene or mixtures of said rubbers or rubber monomers are preferably used as a rubber.

The weight-average molecular weight of said vinyl aromatic polymers is in particular from 1,500 to 2,000,000 g/mol, preferably from 70,000 to 1,000,000 g/mol.

In a preferred embodiment, the second plastics material is selected from SMMA, SAN, ASA, ABS and AES plastics materials, in particular ABS plastics materials.

The second plastics material containing vinyl aromatic polymers, preferably the SMMA, SAN, ASA, ABS and AES plastics material, can also contain further components, e.g. fillers, such as glass fibers, pigments, mineral particles, dyes, rheological aids, demolding aids or stabilizers. The second plastics material, in particular the SAN, ASA, ABS and AES plastics material, preferably consists of the specified vinyl aromatic polymers in an amount of greater than 40 wt. %, in particular greater than 60 wt. %, preferably greater than 70 wt. %, more preferably greater than 90 wt. %, in each based on the total plastics material (with fillers). The second plastics material preferably consists of the specified vinyl aromatic polymers, in particular SAN, ASA, ABS and/or AES polymers, in an amount of greater than 90 wt. %, in particular greater than 95 wt. %, preferably greater than 98 wt. %, in each based on the polymer proportion of the plastics material (total plastics material without fillers). The second plastics material preferably has a content of vinyl aromatic polymers of from 60-100 wt. %, in particular 80-100 wt. %, in each case based on the total plastics material (with fillers).

In another preferred embodiment, the second plastics material has a mixture of at least one polycarbonate and at least one vinyl aromatic polymer, preferably the above-mentioned ones. Said mixture preferably contains more polycarbonate than vinyl aromatic polymers, in particular SMMA, SAN, ASA, ABS and/or AES, preferably ABS. The ratio of polycarbonate, in particular aromatic polycarbonate, to vinyl aromatic polymer, in particular SMMA, SAN, ASA, ABS and/or AES, is preferably from 1:1 to 100:1, in particular from 2:1 to 50:1, preferably from 3:1 to 10:1, in each case based on the parts by weight.

The second plastics material containing a mixture of at least one polycarbonate and at least one vinyl aromatic polymer can also contain further components, e.g. fillers, such as glass fibers, pigments, mineral particles, dyes, rheological aids, demolding aids or stabilizers. The second plastics material preferably consists of the specified mixture of at least one polycarbonate and at least one vinyl aromatic polymer in an amount of greater than 40 wt. %, in particular greater than 60 wt. %, preferably greater than 70 wt. %, more preferably greater than 90 wt. %, in each based on the total plastics material (with fillers). The second plastics material preferably consists of the specified mixture of at least one polycarbonate and at least one vinyl aromatic polymer in an amount of greater than 90 wt. %, in particular greater than 95 wt. %, more preferably greater than 98 wt. %, in each based on the polymer proportion of the plastics material (total plastics material without fillers). The second plastics material preferably has a polymer content of the mixture of at least one polycarbonate and at least one vinyl aromatic polymer of from 50-90 wt. %, in particular 60-80 wt. %, in each case based on the total plastics material (with fillers).

In another preferred embodiment, the second plastics material contains a mixture of at least one polycarbonate and at least one polyester, preferably the above-mentioned polyester plastics materials. The ratio of polycarbonate, in particular aromatic polycarbonate, to polyester, in particular PET and/or PBT, is preferably from 50:1 to 1:50, in particular from 20:1 to 1:20, preferably from 9:1 to 1:9, more preferably from 5:1 to 1:5, in each case based on the parts by weight. A corresponding mixture preferably contains more polycarbonate than polyester, in particular PET and/or PBT.

The second plastics material containing a mixture of at least one polycarbonate and at least one polyester can also contain further components, e.g. fillers, such as glass fibers, pigments, mineral particles, dyes, rheological aids, demolding aids or stabilizers. The second plastics material preferably consists of the specified mixture of at least one polycarbonate and at least one polyester in an amount of greater than 40 wt. %, in particular greater than 60 wt. %, preferably greater than 70 wt. %, more preferably greater than 90 wt. %, in each based on the total plastics material (with fillers). The second plastics material preferably consists of the specified mixture of at least one polycarbonate and at least one polyester in an amount of greater than 90 wt. %, in particular greater than 95 wt. %, preferably greater than 98 wt. %, in each based on the polymer proportion of the plastics material (total plastics material without fillers). The second plastics material preferably has a polymer content of the mixture of at least one polycarbonate and at least one polyester of from 50-90 wt. %, in particular 60-80 wt. %, in each case based on the total plastics material (with fillers).

In another preferred embodiment, the second plastics material contains at least one poly(meth)acrylate. Poly(meth)acrylate is a synthetic, preferably transparent, thermoplastic material. Preferred poly(meth)acrylates are composed of 50 to 100 wt. %, in particular 70 to 100 wt. % acrylate and/or methacrylate, the (meth)acrylate units preferably being esterified with a C1 to C12 alkyl functional group, in particular C1-C4, preferably methyl functional group. The notation poly(meth)acrylate indicates that the polymer is composed of acrylate and/or methacrylate. Accordingly, the notation (meth)acrylate indicates that this can be both an acrylate and a methacrylate. Particularly preferably, the poly(meth)acrylate is a polymethyl methacrylate (PMMA, also known colloquially as acrylic glass or Plexiglas). Preferred polymethyl methacrylates are composed of 50 to 100 wt. %, in particular 70 to 100 wt. %, methyl methacrylate.

As comonomers for the composition of the poly(meth)acrylate, in particular of the polymethyl methacrylate, meth(acrylic acid), in particular acrylic acid, and alkyl esters thereof having 1 to 12 carbon atoms, in particular 1 to 4 carbon atoms in the alkyl functional group, and acrylonitrile and/or methacrylonitrile, acrylamide and/or methacrylamide, styrene and/or maleic acid anhydride may be considered in the first instance. Thermoplastically and thermoelastically deformable plastics materials are preferred. Preferred thermoplastic polymethyl methacrylate plastics materials have weight-average molar masses (weight average Mw) of greater than 50,000 g/mol, in particular greater than 100,000 g/mol. The thermoplastic poly(meth)acrylate plastics materials, in particular polymethyl methacrylate plastics materials, preferably have a weight-average molar mass (weight average Mw) of less than 2,000,000 g/mol, in particular less than 1,000,000 g/mol, preferably less than 500,000 g/mol. Particularly preferred thermoplastic poly(meth)acrylate plastics materials, in particular polymethyl methacrylate plastics materials, have weight-average molar masses (weight average Mw) of from 50,000 g/mol to 250,000 g/mol, e.g. approximately 100,000 g/mol to approximately 180,000 g/mol for the injection molding.

A further component essential to the invention is the use of at least one primer, preferably exactly one primer. The primer contains at least one polymer that contains maleic acid anhydride, in particular a maleic acid anhydride-grafted polyolefin polymer, and at least one polyester, in particular at least one copolyester.

The primer constitutes a welding aid, which is preferably applied as a pre-treatment layer to at least one of the substrate surfaces to be welded, in the region of the joining zone. The primer is not to be understood as an adhesive, cleaning agent or similar; rather, the primer is a welding aid, as a result of which the joining parts are rendered compatible in the joining zone (or welding zone), resulting in integral bonding and a frictional connection between the substrates to be welded when joining occurs in the joining zone.

The experiments have shown that by using a corresponding primer, containing the polymers according to the invention, the plastics materials to be joined could be rendered compatible in the case of welding at the joint seam, thus making it possible to achieve a stable and permanent connection. Without the use of a corresponding primer, no or only very limited strength of the welded connection could be achieved. The joined substrates preferably have a tensile strength of greater than 2 MPa, in particular greater than 5 MPa, preferably greater than 7 MPa. Tensile strength is determined by means of a tensile speed of 5 mm/min according to the experimental techniques described in the experiments.

In a preferred embodiment, the at least one polymer that contains maleic acid anhydride are polymers, in particular copolymers, which contain maleic acid anhydride groups that are reacted or polymerized into their backbone. In this case, a maleic acid anhydride or maleic acid anhydride derivative, in particular maleic acid anhydride, can be reacted or polymerized into the polymer. One example of a maleic acid anhydride derivative is 1,2,3,6-tetrahydrophthalic anhydride, which includes the relevant 5-member anhydride group. In this case, the polymers can contain the maleic acid anhydride groups both polymerized into the backbone, for example in a copolymer consisting of at least one maleic acid anhydride monomer and acrylate and/or alpha-olefin monomers, and also grafted, as with maleic acid anhydride-grafted polyolefins. In a preferred form, the polymer in the primer is a maleic acid anhydride-grafted polyolefin, in particular a maleic acid anhydride-grafted polyethylene and/or maleic acid anhydride-grafted polypropylene, preferably a maleic acid anhydride-grafted polypropylene.

In another particularly preferred embodiment, the primer preferably contains a copolymer which, in addition to the maleic acid anhydride or maleic acid anhydride derivative, contains, polymerized therein, one or more monomers selected from the group of acrylates and methacrylates (together: (meth)acrylates), in particular (meth)acrylates having an alkyl functional group having 1 to 12 carbon atoms, preferably 1 to 4 carbon atoms, preferably ethyl and butyl (meth)acrylate, meth(acrylic) acid and alpha-olefins, in particular ethylene, propene, 1-butene, 1-hexene and 1-octene, preferably ethylene. In addition, functional monomers having functionalities such as epoxide or isocyanate groups, carboxyl or amine groups, but also alkoxysilane groups, can be used. The at least one copolymer particularly preferably contains, polymerized therein, at least one maleic acid anhydride (derivative), a (meth)acrylate and an alpha-olefin, preferably a maleic acid anhydride, a (meth)acrylate having a C1 to C4 alkyl functional group and an ethylene or propylene.

The polymers that contain maleic acid anhydride groups may be synthesized from the monomers in a known manner. Said polymers can also be grafted in a polymer-analogous reaction. Particularly preferred reaction partners for grafting are alcohols, thiols, amines, isocyanates, anhydrides, carboxylic acids, in particular alcohols, preferably alcohols having 1 to 6 carbon atoms, such as methanol and isobutanol. For the grafting, the maleic acid anhydride monomers or maleic acid anhydride units in the polymer can react with the reaction partner, and in particular can be esterified using alcohols. Preferably, only some of the maleic acid anhydride groups react or are esterified, in particular less than 70% of the maleic acid anhydride groups. It is particularly preferable for the maleic acid anhydride groups not to be reacted and to remain as anhydride groups. In the preferred embodiment, the maleic acid anhydride groups can also be hydrolyzed in part. A complete reaction of the maleic acid anhydride groups can lead to a reduction in the strength of the resulting welded connection.

In a preferred embodiment, the at least one polymer that contains maleic acid anhydride is a polyolefinic polymer that contains maleic acid anhydride, such as a homo- and copolymer of alpha-olefins, in particular a maleic acid anhydride-grafted polyolefinic polymer. The preferred polyolefinic polymers can be selected from the group consisting of poly-alpha-olefin homopolymers based on ethene, propene and/or butene, in particular ethylene homopolymers or propylene homopolymers, and poly-alpha-olefin copolymers based on ethene, propene, 1-butene, 1-hexene and 1-octene, in particular ethylene/alpha-olefin and propylene/alpha-olefin copolymers, preferably copolymers of ethene or propene with 1-butene, 1-hexene, 1-octene or a combination thereof.

The polyolefinic polymers may also be halogenated, in particular chlorinated. In this context, chlorinated polyethylene polymers and/or chlorinated polypropylene polymers, in particular chlorinated polypropylene polymers, are preferred. The chlorinated polyolefins, in particular the chlorinated polyethylene and/or chlorinated polypropylene polymers, preferably have a chlorine content of greater than 5 wt. %, in particular greater than 10 wt. %, preferably greater than 15 wt. %. The chlorinated polyolefins, in particular the chlorinated polyethylene and/or chlorinated polypropylene polymers, preferably have a chlorine content of from 5 to 42 wt. %, in particular from 10 to 40 wt. %, preferably from 20 to 35 wt. %. The polyolefinic polymers are preferably not chlorinated, in particular are not halogenated.

The polyolefinic polymers that contain maleic acid anhydride may be synthesized in a known manner. The polyolefin polymers could also contain small amounts of non-alpha-olefin monomers, such as styrene or acrylates. The polyolefin polymers are preferably not block copolymers. In particular, the polyolefins contain less than 10 wt. %, preferably less than 2 wt. %, more preferably less than 1 wt. %, particularly preferably no monomers selected from styrene and acrylates, in particular no alpha-olefin monomers. The polymers could also be further grafted in a polymer-analogous reaction. Particularly preferred reaction partners for grafting are alcohols, thiols, amines, isocyanates, anhydrides, carboxylic acids, in particular alcohols, preferably alcohols having 1 to 6 carbon atoms, such as methanol and isobutanol. For the grafting, the maleic acid anhydride monomers or maleic acid anhydride units in the polymer can react with the reaction partner, in particular using alcohols or using amines. In particular, the polymers can also be further grafted with maleic acid anhydride in order to further increase the maleic acid anhydride content. In particular in the case of mixtures of polyolefins, in particular of polyethylene and polypropylene, said polyolefins can be further grafted, in particular with amines, preferably diamines, in order to be interconnected. Preferably, only some of the maleic acid anhydride groups react, in particular less than 90 mol %, preferably less than 70 mol % of the maleic acid anhydride groups. Preferably, some of the maleic acid anhydride groups are reacted with amines, in particular aliphatic amines, preferably aliphatic diamines, such as hexamethylenediamine. Preferably 5-100 mol %, in particular 10-80 mol %, preferably 20-70 mol % of the maleic acid anhydride groups of the polymer according to the invention, in particular of the maleic acid anhydride groups of a mixture of maleic acid anhydride-grafted polyolefin polymers, are reacted with amines.

In another preferred embodiment, the maleic acid anhydride groups are not reacted and continue to be present as an anhydride. In the preferred embodiment, the maleic acid anhydride groups can also be hydrolyzed in part. A complete reaction of the maleic acid anhydride groups can lead to a reduction in the strength of the resulting welded connection.

Polymers that contain a maleic acid anhydride content of no less than 0.001 wt. %, in particular no less than 0.01 wt. %, preferably no less than 0.02 wt. %, particularly preferably no less than 0.05 wt. % based on the polyolefin polymer, are particularly advantageous. Advantageously, the polymers contain a maleic acid anhydride content of from 0.01-15 wt. %, in particular 0.02-10 wt. %, preferably 0.05-5 wt. % based on the polyolefin polymer. In another preferred embodiment, the polymers contain a maleic acid anhydride content of from 2-15 wt. %, in particular 5-10 wt. % based on the polyolefin polymer. Polyolefin polymers having a corresponding maleic acid anhydride content exhibit particularly good strength in the welded connection.

Advantageously, the polymers that contain maleic acid anhydride, in particular maleic acid anhydride-grafted polyolefin polymers, have a weight-average molecular weight Mw of no less than 5,000 g/mol, in particular no less than 50,000 g/mol, preferably no less than 100,000 g/mol. The polymers preferably have a weight-average molecular weight Mw in the range of from 5,000-2,000,000 g/mol, in particular 50,000-1,000,000 g/mol, preferably 100,000-500,000 g/mol. Polymers having a corresponding weight-average molecular weight have a positive effect on the brittleness and strength of the obtained connection. The weight-average molecular weight can be determined by means of GPC against a polystyrene standard.

In a preferred embodiment, the primer contains a maleic acid anhydride-grafted polyolefin polymer, the polyolefin polymer being selected according to the polyolefin plastics material of the first joining part. This means that, when a polypropylene plastics material is selected as the first joining part, the primer preferably contains a maleic acid anhydride-grafted polypropylene. The primer particularly preferably contains at least one maleic acid anhydride-grafted polypropylene if a polypropylene plastics material is welded, or a maleic acid anhydride-grafted polyethylene if a polyethylene plastics material is welded. The combination of a maleic acid anhydride-grafted polypropylene in the primer with a polypropylene plastics material as the first joining part is particularly preferred.

In addition to the polymer that contains maleic acid anhydride, the primer contains a polyester, preferably a copolyester. Polyesters are obtained by reacting dicarboxylic acids, dicarboxylic acid chlorides and/or anhydrides with corresponding polyfunctional alcohols, in particular bifunctional alcohols. This can involve reaction products of aliphatic, cycloaliphatic or aromatic dicarboxylic acids or anhydrides thereof with aliphatic, cyclic or aromatic polyols. If at least two different carboxylic acids and/or alcohols are used, this is a copolyester. By selecting the carboxylic acids and the polyols, amorphous semi-crystalline or crystalline polyesters and copolyesters can be obtained. Dicarboxylic acids and diols are usually made to react. It is also possible, however, for small amounts of tricarboxylic acids or triols to be used in part. The resulting polymers are preferably not cross-linked and are preferably meltable. Linear polyesters are preferably used. The weight-average molecular weight of suitable polyesters should preferably be between 1,500 and 100,000 g/mol, in particular between 5,000 and 75,000 g/mol, preferably between 15,000 and 50,000 g/mol (determined by means of GPC against a polystyrene standard).

The polyester is preferably produced from at least one aromatic carboxylic acid having 8 to 16 carbon atoms and at least one aliphatic or cycloaliphatic glycol having 2 to 10 carbon atoms as main components. Here, “main component” means that the at least one aromatic carboxylic acid having 8 to 16 carbon atoms and the at least one aliphatic or cycloaliphatic glycol having 2 to 10 carbon atoms make up at least 50 mol %, preferably at least 60 mol %, more preferably at least 65 mol % based on the total amount of the acid component or the alcohol component. Terephthalic acid, isophthalic acid or a mixture thereof is preferably used as the at least one carboxylic acid having 8 to 16 carbon atoms. The polyester can also contain other polybasic carboxylic acids. Examples of other polyvalent carboxylic acids include ortho-phthalic acid, naphthalenedicarboxylic acid, succinic acid, adipic acid, azelaic acid, sebacic acid, decanoic acid, dimer acid, cyclohexanedicarboxylic acid, trimellitic acid, etc.

The alcohol component of the polyester preferably comprises at least one aliphatic or cycloaliphatic glycol having 2 to 10 carbon atoms as the main component. The polyester preferably contains at least one alcohol selected from the group consisting of 3-hydroxy-2,2-dimethylpropyl-3-hydroxy-2,2-dimethylpropanoate (HPHP), ethylene glycol, diethylene glycol, neopentyl glycol, cyclohexanedimethanol, 1,3-propanediol, 1,4-butanediol and 2-methyl-1,3-propanediol as the aliphatic or cycloaliphatic glycol having 2 to 10 carbon atoms.

Specific examples of the combination of the components of suitable polyesters include (terephthalic acid/isophthalic acid)/ethylene glycol=(90-70/10-30)/100 mol %, terephthalic acid/(ethylene glycol/1,2-propylene glycol)=100/(80-50/20-50) mol %, (terephthalic acid/isophthalic acid)/(ethylene glycol/1,3-propylene glycol)=(95-80/5-20)/(90-70/10-30) mol %, (terephthalic acid/isophthalic acid)/(ethylene glycol/butanediol-1,4)=(95-70/5-30)/(90-50/10-50) mol %, terephthalic acid/(ethylene glycol/2-methyl-1,3-propanediol)=100/(60-80/40-20) mol %, (terephthalic acid/isophthalic acid)/(ethylene glycol/2-methyl-1,3-propanediol)=(95-80/5-20)/(70-90/30-10) mol %, terephthalic acid/(ethylene glycol/neopentyl glycol)=100/(85-60/15-40) mol %, (terephthalic acid/isophthalic acid)/(ethylene glycol/neopentyl glycol)=(95-80/5-20)/(90-70/10-30) mol %, terephthalic acid/(ethylene glycol/diethylene glycol)=100/(75-50/25-50) mol %, (terephthalic acid/isophthalic acid)/(ethylene glycol/diethylene glycol)=(95-80/5-20)/(90-75/10-25) mol %, and terephthalic acid/(ethylene glycol/1,4-cyclohexanedimethanol)=100/(80-60/20-40) mol %.

Examples of the more preferable combination include terephthalic acid/(ethylene glycol/neopentyl glycol)=100/(85-60/15-40) mol %, (terephthalic acid/isophthalic acid)/(ethylene glycol/neopentyl glycol)=(95-80/5-20)/(90-70/10-30) mol %, terephthalic acid/(ethylene glycol/diethylene glycol)=100/(75-50/25-50) mol %, (terephthalic acid/isophthalic acid)/(ethylene glycol/diethylene glycol)=(95-80/5-20)/(90-75/10-25) mol % and terephthalic acid/(ethylene glycol/1,4-cyclohexanedimethanol)=100/(80-60/20-40) mol %.

In addition to ethylene glycol, diethylene glycol, neopentyl glycol, cyclohexanedimethanol, 1,3-propanediol, 1,4-butanediol and 2-methyl-1,3-propanediol, the polyester may contain other polyhydric alcohols as alcohol components. Examples of other polyhydric alcohols include 1,2-butanediol, 1,3-butanediol, 1,5-pentanediol, 3-methyl-1,5-pentanediol, hexanediol, nonanediol, dimer diol, ethylene oxide and/or propylene oxide adducts of bisphenol A, bisphenol F, polyethylene glycol, polypropylene glycol, polytetramethylene glycol, 2-butyl-2-ethyl-1,3-propanediol, tricyclodecanedimethanol, neopentyl hydroxypivalic acid neopentyl glycol ester, 2,2,4-trimethyl-1,5-pentanediol and trimethylolpropane.

Particularly preferred polyesters contain terephthalic acid and/or isophthalic acid as an acid component. Copolyesters containing, polymerized therein, both terephthalic acid and isophthalic acid are particularly preferred, with more terephthalic acid than isophthalic acid preferably being used.

In one embodiment, the polyester used is preferably an amorphous polyester. In another preferred embodiment, the polyester used is preferably a semi-crystalline or crystalline polyester. Here, the term “amorphous polyester” describes a polyester that does not have a melting peak in the second heating step when heated from −100° C. to 300° C. at a heating rate of 10 K/min, cooled again to −100° C. at a cooling rate of 50 K/min and heated again from −100° C. to 300° C. at a heating rate of 10 K/min, using a differential scanning calorimeter (DSC). The term “semi-crystalline or crystalline polyesters” describes polyesters which have a melting peak in one of the two heating steps.

In a preferred embodiment, the semi-crystalline or crystalline polyester has a melting peak with a maximum of from 80 to 220° C. The lower limit of the melting peak maximum is preferably 100° C., particularly preferably 110° C., while the upper limit of the melting peak maximum is preferably 200° C., particularly preferably 190° C. (determined by means of DSC at a heating rate of 10 K/min). Corresponding polyesters are particularly well suited for applications in which the welded products are exposed to higher temperatures, e.g. temperatures above 80° C.

The crystalline polyester contains, based on the total amount of the alcohol component (100 mol %), at least 50 mol %, more preferably at least 55 mol %, particularly preferably at least 60 mol % of at least one alcohol from the group consisting of ethylene glycol, 1,3-propanediol, 1,4-butanediol, 1,6-hexanediol and cyclohexanedimethanol.

The at least one polyester can be both acid-group-terminated and hydroxyl-group-terminated. In a particularly preferred embodiment, the primer contains at least one hydroxyl-group-terminated polyester, in particular a hydroxyl-group-terminated copolyester.

The primer preferably contains the at least one polymer that contains maleic acid anhydride, in particular the preferred polymers that contain maleic acid anhydride, in an amount of from 10 to 90 wt. %, in particular 20 to 80 wt. %, preferably 25 to 70 wt. %, particularly preferably 30 to 60 wt. %, in each case based on the polymer content of the primer, in particular in each case based on the total weight of the primer. The primer preferably contains the at least one polyester, in particular the preferred copolyesters described above, in an amount of from 10 to 90 wt. %, in particular 20 to 80 wt. %, preferably 25 to 70 wt. %, particularly preferably 30 to 60 wt. %, in each case based on the polymer content of the primer, in particular in each case based on the total weight of the primer. The primer particularly preferably contains the at least one polymer that contains maleic acid anhydride and the at least one polyester in a weight ratio of from 5:1 to 1:5, in particular from 2:1 to 1:2, preferably from 1.5:1 to 1:1.5, more preferably from 1:1 to 1:1.5. In a further preferred embodiment, the primer has a smaller weight fraction of the maleic acid anhydride-containing polymer compared with the weight fraction of the polyester.

In addition to the maleic acid anhydride-containing polymer and the polyester, the primer can preferably contain at least one further polymer. The at least one further polymer or copolymer is preferably compatible with at least one of the two plastics materials to be welded and with at least one of the primer polymers. The primer preferably contains at least one further polymer on which one of the plastics materials to be joined is based, preferably those specified above in each case. The use of an additional polymer alongside the (co)polymers in the primer according to the invention can lead to further improvements in strength.

As a compatible further polymer, a polymer is preferably used which has a weighted squared distance of the Hansen parameters (Rₐ)² of less than 22 MPa, in particular less than 17 MPa, preferably less than 15 MPa, particularly preferably less than 12 MPa with respect to one, in particular with respect to the two plastics materials to be joined, and in particular also with respect to at least one of the above-mentioned primer polymers according to the invention.

The weighted squared distance of the Hansen parameters (Rₐ)² is determined according to the following formula:

(Rₐ)²=4(Δδ_{D})²+(Δδ_{P})²+(Δδ_{H})²

In this formula, δ_{D} is the Hansen parameter for the dispersion forces, δ_{P} is the Hansen parameter for the polarity and δ_{H} is the Hansen parameter for the hydrogen bridge bonds. Δδ_{D}, Δδ_{P} and Δδ_{H} each represent the differences of these Hansen parameters from the plastics materials or polymers to be compared, e.g. Δδ_{D}=(δ_{D1}−δ_{D2}) of polymers 1 and 2. The values of the individual Hansen parameters δ_{D}, δ_{P} and δ_{H} for the respective plastics materials or polymers are determined according to the book “Hansen Solubility Parameters: A User's Handbook” by Charles M. Hansen (second edition; Taylor & Francis Group; 2007; ISBN-10 0-8493-7248-8). Numerous values for individual polymers can already be retrieved using this source. According to the method described in this book, the Hansen parameters are preferably retrieved from the supplied database using the HSPIP program (4th edition 4.1.07) or, if they are not there, using the “DIY” functionality contained in the program, preferably using the supplied neural network as described in the help section. The HSPIP program can be obtained from Steven Abbott TCNF Ltd.

The content of the further polymer in the primer is preferably 1-40 wt. %, in particular 5-30 wt. %, particularly preferably 10-20, in each case based on the total weight of the primer. The content of the further polymer in the polymer content of the primer is preferably 5-75 wt. %, in particular 30-70 wt. %, particularly preferably 40-65 wt. %, in each case based on the total polymer proportion of the primer (primer without solvents and without fillers).

In addition to the (co)polymers and the further polymer, the primer can also contain a solvent, in particular an organic solvent. The primer preferably has a solvent content of from 10-90 wt. %, in particular 50-85 wt. %, particularly preferably 60-80 wt. %, in each case based on the total weight of the primer.

Suitable solvents are all conventional solvents, for example water, alcohols, ketones such as methyl isobutyl ketone (MIBK) or cyclohexanone (CH), ethers such as diethyl ether or tetrahydrofuran (THF), esters such as acetic acid ethyl ester, or carbonates such as dimethyl or dipropyl carbonate, xylene, toluene, or mixtures thereof.

In a preferred embodiment, the primer contains organic solvents. Particularly preferred solvents are solvents that have a vapor pressure at 20° C. of from 1 to 600 hPa, in particular 2 to 200 hPa, particularly preferably 5 to 20 hPa. Solvents that have a corresponding vapor pressure have proven particularly advantageous in minimizing or preventing bubble formation in the primer layer during evaporation. The primer particularly preferably contains a solvent selected from tetrahydrofuran, methyl isobutyl ketone, cyclohexanone and mixtures thereof, and the primer more preferably contains tetrahydrofuran or a mixture of methyl isobutyl ketone and cyclohexanone. If a mixture of methyl isobutyl ketone and cyclohexanone is used as a solvent, said mixture preferably contains 10-50 wt. %, in particular 20-35 wt. % cyclohexanone, in each case based on the total mixture of solvent.

If organic solvents are used, the total polymer content of the primer is preferably 10-90 wt. %, in particular 15-50 wt. %, particularly preferably 20-40 wt. %, in each case based on the total weight of the primer. The total polymer content corresponds to the content of all the polymers used in the primer, in particular the polymers according to the invention and the above-described further polymers.

In another preferred embodiment, the primer is in the form of an aqueous dispersion or emulsion. In this case, the polymers according to the invention or, if present, the further polymers are emulsified or dispersed in water. In this case, the total polymer content of the primer is preferably 2-90 wt. %, in particular 5-50 wt. %, particularly preferably 10-35 wt. %, in each case based on the total weight of the primer. It is advantageous for the aqueous dispersion/emulsion for the polymer component to consist substantially of only the polymers according to the invention and the optionally present above-mentioned further polymer, in particular only the polymers according to the invention. According to the invention, the term “substantially” is understood to mean when the polymer component consists of more than 95 wt. %, preferably more than 97 wt. %, most particularly preferably more than 99 wt. % of the polymers according to the invention and the optionally present above-mentioned further polymer, in particular only the polymers according to the invention.

In addition to the polymers according to the invention, the above-mentioned further polymers and a solvent, the primer may contain further components, for example fillers, (fluorescent) dyes and pigments, rheological aids, defoaming aids, emulsifiers, surfactants, wetting aids, stabilizers or plasticizers. With the exception of dyes, stabilizers, in particular thermostabilizers and hydrolysis stabilizers, pigments and surfactants, the primer is, however, preferably substantially free of further components, in particular substantially free of any other components. According to the invention, the term “substantially free from” means when the primer contains less than 5 wt. %, preferably less than 1 wt. %, most particularly preferably less than 0.1 wt. % of the respective substances, in particular does not contain the respective substances.

The primer preferably contains at least one stabilizer, in particular at least one thermostabilizer and/or hydrolysis stabilizer, preferably in an amount of from 0.01 to 10 wt. %, in particular 0.1 to 7 wt. %, preferably 1 to 5 wt. %, in each case based on the total amount of the primer.

A primer is used in the method according to the invention for welding a polyolefin plastics material to a second plastics material, the primer containing at least one polymer that contains maleic acid anhydride, in particular at least one maleic acid anhydride-grafted polyolefin polymer, and at least one polyester, in particular at least one copolyester.

In the method according to the invention, the primer is used as an aid for welding the two different plastics materials by melting in each case. As a result of the primer used, which contains a polymer according to the invention, compatibility arises between the two joining parts, as a result of which stable and permanent integral bonding can be produced between the two plastics materials.

The primer can be applied to the surface of one or both joining parts using a wide range of methods. For example, the application can take place by means of a dosing device, a needle and dosing robot, injection molding, extrusion, film application, application as a hot melt, spraying, spreading or dipping. In the process, the primer can either be applied to only one surface or to both surfaces of the substrates to be welded.

If the primer contains solvent, the primer is preferably dried after application to one or both surfaces until the solvent has evaporated such that a non-adhesive, dimensionally stable primer layer remains. In particular, the primer can be welded after only a few seconds and remains weldable for up to several weeks. Preferably, the primer is dried for at least an hour, preferably for at least 12 hours after application.

Preferably, the application to one or both surfaces of the substrates to be welded is such that the primer has a layer thickness of from 1 μm to 5,000 μm, in particular 100-3,000 μm, preferably 300-2,000 μm, particularly preferably 500-1,000 μm. Above all, layer thicknesses of greater than 100 μm are preferred. If a solvent was contained in the primer, the layer thickness refers to the primer dried by the solvent.

Following application to one or both surfaces of the substrates to be welded and optionally following drying of the primer, the substrates to be welded can be interconnected by means of a conventional welding method. Plastics materials are generally welded by local plasticizing of the joining parts in the joining plane and by pressurized joining. The process parameters can be selected such that a pronounced squeeze flow of the melt leads to an optimum connection of the joining parts in the joining plane. The heating can take place by means of convection, heating by contact, radiation or friction. The varying energy input for the plasticizing can take place in a number of ways, and has led to different methods for welding plastics materials. Suitable welding methods are, for example:
Hot gas welding [HG]
   Convective heating by means of a hot gas flow, generally air, two-stage process
Hot plate welding [HP]
   Heating by contact, two-stage process
Ultrasonic welding [US]
   Heating by friction: a transverse wave in the ultrasonic range induces heating in the boundary layer, single-stage process
High-frequency welding [HF]
   Heating by internal friction: polar molecules are oriented according to a high-frequency magnetic field, single-stage process, only used for polar plastics materials and films
Vibration welding [VIB] (linear; orbital; spin; angle)
   Heating by friction, single-stage process
Laser welding [LW] (contour, simultaneous, quasi-simultaneous, mask)
   Heating by radiation, coherent radiation, laser transmission welding, generally single-stage process (two-stage is possible)
Infrared welding [IR]
   Heating by radiation, incoherent radiation, two-stage process

The above-described welding methods can optionally also be combined, for example infrared welding with vibration welding. The plastics materials are preferably welded using a welding method selected from hot plate welding, thermal contact or impulse welding, warm or hot gas welding, microwave or induction welding. Laser butt or penetration welding, infrared welding, ultrasonic welding and combinations thereof, in particular selected from infrared welding, hot plate welding, vibration welding, ultrasonic welding and combinations thereof.

A method containing the following steps is particularly preferred for integrally joining the two plastics using the primer:
Providing the first plastics material having a first joining zone,
Providing the second plastics material having a second joining zone,
Pre-heating the first joining zone,
Applying the primer to the pre-heated first joining zone, in particular in the case of solvent-free primers,
Bringing the first joining zone provided with the primer into contact with the second joining zone,
Integrally bonding the first joining zone and the second joining zone, in particular by using conventional methods for welding plastics materials, such as infrared welding, hot plate welding, warm gas welding, vibration welding or ultrasonic welding.

The teaching of DIN 1910-3:1977-09 can generally be applied to welding plastics materials. This can therefore be understood as integrally bonding thermoplastic materials with the aid of heat and/or pressure. The heating can take place for example on the basis of heating by contact (welding by solid bodies), convection heating (welding by warm gas), radiation heating (welding by beams) and heating by friction (welding by movement), as well as welding by electric current.

In an advantageous development, a primer is used which is selected and tailored to the method such that the application to a heated and/or hot joining zone at a temperature that is lower than the decomposition temperature of the polymers in the primer has no impact on the internal chemical cross-linking of the primer.

It is advantageous to pre-heat the first joining zone of the first plastics material. Aids and techniques that are known to a person skilled in the art and are suitable for the intended use can be used for the pre-heating. The use of hot gas or plasma is particularly useful for pre-heating. It is also conceivable for pre-heating to take place by means of radiation, in particular infrared radiation or laser radiation. A hot plate or a heated tool can also be used to pre-heat the first joining zone. Finally, pre-heating in a furnace or a heated chamber is also conceivable. It is conceivable to pre-heat the whole plastics material and thus also said joining zone. Alternatively or additionally, pre-heating only the joining zone itself is also possible.

In an advantageous development, the distance during pre-heating between the heating device and the plastics material, in particular the first joining zone to be pre-heated, in particular the distance of the heat-emitting region of the heating device or the heat-releasing region of the heating device or the active surface of the heating device to be pre-heated or the region of the heating device that is opposite the first joining zone, is in a range of from 0.5 mm to 100 mm, preferably in the range of from 1 mm to 60 mm. Alternatively, it is also conceivable for heating to take place by and/or upon in particular the first joining zone being contacted by the hot plate of the heating device.

A further advantage is selecting the plastics material for the first joining part and adjusting the method parameters to the first plastics material such that the first joining zone is melted during pre-heating, and a melt layer is produced in the first joining zone during pre-heating. The thickness of the melt layer in a preferred embodiment is preferably in the range of from 0.05 mm to 6 mm, particularly preferably in the range of from 0.1 mm to 5 mm. A melt layer of this kind can lead to improved adhesion and/or diffusion and/or interaction of the molecules and, in conjunction with a certain flow, can lead to an improved connection layer. If the boundary layer of the first plastics material is in the molten state, there can be interactions with the primer which go as far as chemical bonds. The melt layer can in particular depend on the component geometry and the particular component design. Preferably, the method parameters are adjusted and/or selected such that the components are not deformed. Preferably, differences in temperature between the joining zone and the primer to be applied can be compensated for by taking suitable measures and/or method steps. In this case, it is in particular conceivable to pre-heat the primer in order to reduce the difference in temperature between the preferably thermoplastic primer and the first joining zone. This can counteract the rapid cooling of the first joining zone between the method steps, for example.

Optionally, pre-treatment of the first joining zone takes places before the step of pre-heating the first joining zone. Alternatively or in addition, the second joining zone can also be pre-treated. Cleaning by means of a solvent or an alkaline (for example) plastics cleaner is also conceivable as a possible pre-treatment, for example. Mechanical pre-treatment can also be used, in particular by means of scraping, sanding, brushing or radiation. Conceivable chemical pre-treatments are in particular acid cleaning or the use of reactive gases. The use of a thermal, chemical and/or physical pre-treatment could also be expedient, in particular by means of a gas flame or plasma arc. Alternatively or in addition, electrical pre-treatment can take place by means of corona discharge, in which the first joining zone and/or the second joining zone is subjected to electrical corona discharge, resulting in polar molecules on the corresponding surface. Another possibility is plasma treatment, preferably using a plasma nozzle for pre-treating the joining zone, in particular in order to achieve activation and/or cleaning of the corresponding surface. Coating by means of plasma can also be expedient. A further possibility is flame treatment of the joining zone in order to increase the surface tension in suitable plastics materials. A further form of pre-treatment is radiation by means of UV rays, electron beams, radioactive rays or by means of lasers. Finally, the pre-treatment can be in the form of a coating, in particular a coat of paint or an adhesion promoter. Pre-treating the first plastics material or the joining zones of the first plastics material such that there is a longer timer interval before the pre-heating is also conceivable. For example, it is conceivable for the pre-treatment to be carried out as part of the manufacturing process of the first plastic& material in order for the pre-treated plastics material to be further processed in the method according to the invention.

It is conceivable for the primer to be applied in a number of ways. For example, and in particular in industry, application by means of an automatic application aid, in particular by means of a dosing robot, is conceivable. Said robot may be provided with a needle and/or height sensor in this case, in order to be able to carry out complex dosing. The primer can also be applied by means of injection molding, in which the primer is plasticized in an injection molding machine and pressure-injected into the mold containing the first plastics material having the first joining zone. Alternatively, film-application is also conceivable, in which, in a first step, a film is produced from the primer by means of film blowing or cast film extrusion. Subsequently, the film can for example be adapted into any desired shape by means of a cutting or stamping process and, in a further step, can be applied to the first joining zone following the above-mentioned pre-heating. In this case, the use of films/sheets having a thickness in the range of from 1 μm -5,000 μm has proven to be expedient. Further conceivable application options are extrusion welding, in which the primer is in the form of a welding wire, or is melted in an extruder and can be applied to the first joining zone as a melt. The primer can also be provided in the form of a welding wire in order to make application by means of hot air welding possible. Applying the primer by means of a spraying process is a further possibility. Pre-treatment and/or pre-heating and/or local variations in the temperature of the injection mold are also possible in the case of application by injection molding. Of course, other types of application that are known to a person skilled in the art and are suitable for the specific implementation are also conceivable.

A further advantage is the further heating or heating of the first joining zone during application of the primer, in particular in order to avoid the temperature of the first joining zone dropping between pre-heating and application of the primer. This can take place by means of the above-described pre-heating method step, which is continued during application for the sake of convenience. Alternatively or in addition, additional heating is possible in particular by means of a further method step. For example, it can be expedient for simultaneous heating of the first joining zone to be carried out, for example by means of simultaneous radiation of the first joining zone, forced convection or heating by contact during application, in order to avoid the temperature of the first joining zone dropping after pre-heating.

In an advantageous development, the primer is applied such that a connection layer having a thickness in the range of from 1 μm to 5 mm, preferably in the range of from 10 μm to 3 mm, is arranged on the first joining zone. The thickness of the connection layer is in this case to be understood as the material thickness of the connection layer on the first joining zone.

A further advantage is applying the primer to the first joining zone by means of a dosing device, by way of a relative movement between the first joining zone and the dosing device, the first joining zone to which the primer is applied being pre-heated by means of a heating device, by way of a relative movement between the first joining zone and the heating device, before the primer is applied, and the primer being applied by means of the dosing device when the first joining zone is pre-heated.

In this regard, it has proven advantageous for the heating device to be guided past the first joining zone at a speed in the range of from 10 mm/min to 100 min, preferably in the range of from 10 mm/min to 30 m/min during pre-heating.

It can also be advantageous for the dosing device to trail the heating device, preferably at a defined and constant spacing. It is particularly advantageous for the method to be carried out such that the primer is applied to the first joining zone by means of a dosing device, by way of a relative movement of the dosing device and the first joining zone in the range of from 10 mm/min to 100 m/min, preferably in the range of from 10 mm/min to 30 m/min, said joining zone to which the primer is applied being pre-heated by means of a heating device before the primer is applied by way of a relative movement of the heating device and the first joining zone, and the dosing device or a nozzle of the dosing device for applying the primer simultaneously trailing the heating device at a time interval in the range of from 0.1-10 s.

In this regard, it has proven advantageous to use a coating unit consisting of a dosing device and a heating device. A coating unit is in this case to be understood in particular as a unit which provides a rigid connection between the heating device and the dosing device such that the dosing device trails the heating device preferably at a defined and constant spacing during the relative movement, in order to ensure that the first joining zone is pre-heated immediately before the primer is applied. Of course, in this regard, adjusting the spacing or, in the case of convective pre-heating, adjusting the volumetric flow rate or the nozzle diameter of the medium, in particular using suitable mechanical or electromechanical or also pneumatically operated adjusters, is also conceivable.

Alternatively, the coating unit can also be understood to mean a heating device and a dosing device as two completely independent or separate assemblies which, however, perform the same or substantially the same relative movement with respect to the plastics material in order to ensure that the location intended for primer application is pre-heated immediately before the primer is applied.

In an advantageous development, although the heating device and the dosing device perform substantially the same primary relative movement or have substantially the same basic orientation with respect to the plastics material, at least one of the two specified devices undergoes, in addition to said primary relative movement, an additional relative movement with respect to the plastics material. For example, the heating device and/or the dosing device can, in addition to the primary relative movement in which for example the primer can also be applied, perform one or more secondary relative movements. For example, in particular the heating device and/or the dosing device can perform or undergo a secondary relative movement that revolves around the primary relative movement or is meander-like.

In this process, the plastics material on the one hand, or the heating device and the dosing device, or the two devices together as the coating unit, on the other hand, can be moved. This process makes it possible for the heating device and the dosing device, or the two devices together as the coating unit, on the one hand, or the plastics material on the other hand, to stand still, or in each case to be moved by means of the moving part thereof in different directions.

In an advantageous development, there is a primary relative movement at a speed in the range of from 10 mm/min to 100 m/min, preferably in the range of from 10 mm/min to 30 m/min, and therefore, in particular also on account of the heating device being suitably designed, the plastics material spends as little time as possible inside the heating surface of the heating device, in particular in a range of from 1-60 s. This can include the region or space around the heating device, which has an impact on the temperature by way of a temperature increase, thus pre-heating the first joining zone of the first plastics material. Heating that is too high and damage to or deterioration of the plastics material can thus be avoided, for example.

It can also be advantageous, in particular for attaching the dosing device and/or the heating device to/into existing production lines, to provide the heating device with a bus interface, in particular a PROFIBUS or a real-time Ethernet interface.

After applying said primer, the second joining zone is brought into contact with the primer layer. In this regard, it can be expedient to fasten the two plastics materials to one another, in particular by means of clamping devices or other fastening aids which are known to a person skilled in the art.

Of course, the second joining zone can optionally be pre-treated before the step of bringing the second joining zone into contact with the primer layer. In this case, in particular all the techniques described above are conceivable for pre-treatment. Pre-treating the second plastics material or the joining zones of the second plastics material such that there is a longer time interval before the contacting is also conceivable. For example, it is conceivable for the pre-treatment to be carried out as part of the manufacturing process of the second plastics material in order for a pre-treated plastics material to be further processed in the method according to the invention. Pre-treating the second plastics material can also include applying the primer to the second joining zone. In this case, it is preferably conceivable for the second joining zone to also be pre-heated before the primer is applied. The above-mentioned embodiments are also preferred at this stage.

A joining process follows on from the above-described contacting of the second joining zone and the primer, in which process the treated and/or coated joining parts are plasticized using a heat supply and preferably integrally bonded to one another under the effect of pressure. For said integral bonding between the second joining zone and the primer, it is conceivable to use a heat supply by means of thermal conduction, for example by means of hot plate welding and/or thermal contact welding and/or thermal impulse welding; by friction, in particular ultrasonic, friction/vibration or high-frequency welding; microwave or induction welding; by convection, for example warm gas or hot gas welding; by means of radiation, for example infrared, laser butt or laser penetration welding, or also by combining two or more of these techniques.

This invention also relates to items or products produced in accordance with the method according to the invention.

This invention further relates to the use of a primer according to the invention for welding a polyolefin plastics material to a plastics material.

### EMBODIMENTS

### Materials Used and Abbreviations

PP=polypropylene
PMMA=polymethyl methacrylate
PBT=polybutylene terephthalate
SAN=styrene acrylonitrile
PET=polyethylene terephthalate
PC=polycarbonate
ABS=acrylonitrile butadiene styrene
MAH=maleic acid anhydride
IR: infrared welding; IR-VIB: infrared/vibration welding; US: ultrasonic welding

Copolyester 1: amorphous copolyester containing, as the monomer, isophthalic acid, terephthalic acid, HPHP glycol, neopentyl glycol and ethylene glycol having a molecular weight of 15,000 g/mol

Copolyester 2: semi-crystalline copolyester containing, as the monomer, isophthalic acid, terephthalic acid, adipic acid and butanediol having a molecular weight of 18,000 g/mol and a melting peak maximum of 138° C.

Copolyester 3: semi-crystalline copolyester containing, as the monomer, isophthalic acid, terephthalic acid and butanediol having a molecular weight of 20,000 g/mol and a melting peak maximum of 179° C.

PP-MAH 1: Acrylate-modified maleic acid anhydride-grafted polypropylene

PP-MAH 2: Maleic acid anhydride-modified polypropylene with an MAH content of 0.25 wt. %

PP-MAH 3: Maleic acid anhydride-modified polypropylene with an MAH content of 7 wt. %

### EXAMPLE 1

For a hotplate welding method, a primer was prepared from copolyester 1 and PP-MAH 1 or PP-MAH 2 in a ratio of 50:50 w/w. By means of a hotplate, a melt was produced on a PP and a non-polyolefinic joining part, immersed in a melt of the primer and then joined together. This hot plate welding resulted in the following tensile strengths of the welded samples with a compatibilizing intermediate layer 24 hours after welding.

TABLE 1

| Plastics | Plastics | | Tensile strength |
|---|---|---|---|
| material 1 | material 2 | | at RT |
| joining part | joining part | Compound | in N/mm² |
| PP | PC | Copolyester 1/ | 2.04 |
| | PMMA | PP-MAH 1 | 6.23 |
| | PBT | | 3.83 |
| | PET | | 6.75 |
| | ABS | | 5.19 |

TABLE 2

| Plastics | Plastics | | Tensile strength |
|---|---|---|---|
| material 1 | material 2 | | at RT |
| joining part | joining part | Compound | in N/mm² |
| PP | PC | Copolyester 1/ | 4.87 |
| | PMMA | PP-MAH 2 | 6.93 |
| | PBT | | 9.68 |
| | PET | | 9.44 |
| | ABS | | 8.00 |

As a result, both the very good adhesion of the primer to PP and the non-polyolefinic polymer as well as the excellent weldability of the otherwise incompatible plastics materials could be demonstrated. Without an additional intermediate layer, no significant and measurable results could be achieved.

### EXAMPLE 2

In a further experiment, a primer was prepared from copolyester 1/PP-MAH 2/PP-MAH 3 in a ratio of 50:25:25 w/w/w. In this process, the MAH content was significantly increased by the further PP-MAH. In the hot plate welding method as described above, this primer resulted in 16.89 N/mm² for PP-PET.

### EXAMPLE 3

For applications at a higher temperature, semi-crystalline copolyester 2 and copolyester 3 were each used with PP-MAH 2 in a 50:50 w/w mixture.

The hot plate welding experiments carried out according to the above method demonstrated the following tensile strengths:

TABLE 3

| | | | Tensile strength |
|---|---|---|---|
| Plastics | Plastics | Primer | at RT in |
| PP | PMMA | Copolyester 2/ | 11.6 |
| | PC | PP-MAH 2 | 4.9 |
| | ABS | | 11.0 |
| | PET | | 16.0 |
| | SAN | | 15.3 |

TABLE 4

| | | | Tensile strength |
|---|---|---|---|
| Plastics | Plastics | Primer | at RT in |
| PP | PMMA | Copolyester 3/ | 7.6 |
| | PC | PP-MAH 2 | 15.3 |
| | ABS | | 12.1 |
| | PET | | 13.6 |
| | SAN | | 11.2 |

Thus, very high strengths were achieved for the specified material combinations.

### EXAMPLE 4

In order to investigate the adhesion to the non-polyolefinic joining part, the mixing ratio of copolyester to PP-MAH was varied from 50:50 to 60:40 and 70:30 (parts by weight). For this purpose, the primer was prepared accordingly from copolyester 3 and PP-MAH 2, and the materials welded according to the described hotplate welding method demonstrated the following strengths:

TABLE 5

| | Strength at | Strength at RT at | Strength at RT at |
|---|---|---|---|
| | mixing ratio | mixing ratio | mixing ratio |
| PP with plastics | of 50/50 in | of 60/40 in | of 70/30 in |
| material | N/mm² | N/mm² | N/mm² |
| PMMA | 7.61 | 8.52 | 7.54 |
| PC | 15.29 | 15.19 | 5.66 |
| ABS | 12.05 | 10.53 | 7.29 |
| PET | 13.57 | 13.47 | * |
| SAN | 11.24 | 16.47 | * |

* Since the 70/30 mixing ratio did not show very high strength after welding, this mixing ratio was not tested for PET and SAN.

### EXAMPLE 5

Machine ultrasonic welding was carried out using standard AWS specimens consisting of two T-shaped joining parts. The compatibilizing primer layer consisting of copolyester 1 and PP-MAH 2 in a ratio of 50:50 (parts by weight) was pressed as a film by means of a hot press, cut into strips, placed on the melt after pre-heating one of the T specimens and melted using warm gas. Subsequently, the second T joining part was welded to the coated joining part by means of ultrasound. In addition to the normal tensile strength after 24 hours, the tensile strength after aging was determined, for which purpose the samples were aged in the alternating climate test in 10 cycles per 8 hours between −30 and +60° C. at 98% r.h. 24 hours after welding or after aging, the following tensile strengths were obtained for the various PP-PET material combinations:

TABLE 6

| PP types | Tensile strength | Tensile strength |
|---|---|---|
| from various | at RT before | at RT after |
| manufacturers | aging in N/mm² | aging in N/mm² |
| PP 1 | 7.56 | 5.42 |
| PP 2 | 6.68 | 6.13 |
| PP 3 | 5.71 | 7.60 |

According to the table, a very high strength was obtained for the welded samples having a compatibilizing primer intermediate layer. In contrast, a reference without a primer layer had no measurable strength.

In the same method, PP-PC and PP-PA were welded and tested in the tensile test directly or after an alternating climate test:

TABLE 7

| Plastics | Plastics | Tensile strength | Tensile strength |
|---|---|---|---|
| material | material | at RT before | at RT after |
| 1 | 2 | aging in N/mm² | aging in N/mm² |
| PP | PC | 4.88 | 2.95 |
| | PA6 | 7.35 | 7.38 |

A very high tensile strength was also measured in this experiment.

The following table shows the tensile strengths before and after aging in the specified methods using other primer layers (in each case 50:50 w/w ratio):

TABLE 8

| Plastics | Plastics | | Tensile strength | Tensile strength |
|---|---|---|---|---|
| material | material | | at RT before | at RT after |
| 1 | 2 | Primer | aging in N/mm² | aging in N/mm² |
| PP | PMMA | Copolyester | 5.99 | 3.53 |
| | | 2/PP-MAH 2 | | |
| | | Copolyester | 6.20 | 3.40 |
| | | 3/PP-MAH 2 | | |

Thus, very high strengths could also be obtained with semi-crystalline copolyester in the primer layer.

### EXAMPLE 6

For infrared welding, plates were used which consisted of the polymers to be joined and were coated at the plate edge of 130*3 mm² with the primer. The application method was the same as described for ultrasonic welding. Using a primer consisting of copolyester 1 and PP-MAH 2 (50:50 w/w), the polymer combinations PP-PC, PP-PMMA and PP-ABS exhibited the following tensile strengths after welding, with and without aging:

TABLE 9

| | Tensile strength | Tensile strengths |
|---|---|---|
| Plastics material | at RT before | at RT after |
| combination | aging in N/mm² | aging in N/mm² |
| PP/PC | 7.44 | 4.94 |
| PP/ABS | 6.36 | 3.98 |
| PP/PMMA | 5.43 | 2.09 |

The results have shown that the primer was also suitable for IR welding. Without a primer, the plastics materials could not be welded. Using copolyester 3 instead of copolyester 1 in the same experiment meant that even strengths of 15.9 N/mm² for PP/PC and 10.4 N/mm² for PP/ABS could be obtained.

1. A method for welding a polyolefin plastic material to a second plastic material, comprising:
providing the polyolefin plastic material having a polyolefin surface including a first joining zone;
providing the second plastic material having a surface including a second joining zone;
providing a primer, wherein the primer comprises a polymer that contains maleic acid anhydride and a polyester polymer;
applying the primer to at least one surface to form a primer layer over the joining zone;
disposing the first joining zone into contact with the second joining zone wherein the primer is disposed between the joining zones; and
welding the polyolefin material to the second plastic material at the joining zones.

2. The welding method according to claim 1, wherein the polyolefin plastic material is selected from polyethene plastic material or polypropylene plastic material.

3. The welding method according to claim 1, wherein:
a) the polyolefin plastic material contains a polyethylene and/or polypropylene polymer in an amount of greater than 90 wt. %, in each case based on the total polyolefin plastics material; or
b) the polyolefin plastic material has a molar mass (weight average Mw) of greater than 10,000 g/mol; or
both a) and b).

4. The welding method according to claim 1, wherein the second plastic material is selected from polycarbonate (PC), acrylonitrile butadiene styrene (ABS), polymethyl methacrylate (PMMA), polyethylene terephthalate (PET), polybutylene terephthalate (PBT), polystyrene (PS), polystyrene acrylonitrile (SAN), polyacrylic ester styrene acrylonitrile (ASA), methyl methacrylate acrylonitrile butadiene styrene (MABS), high impact polystyrene (HIPS), polyamide (PA) or mixtures thereof.

5. The welding method according to claim 1, wherein the primer polymer that contains maleic acid anhydride is a maleic acid anhydride-grafted polyolefin polymer.

6. The welding method according to claim 1, wherein the at least one polymer that contains maleic acid anhydride has a weight-average molecular weight in the range of from 5,000-2,000,000 g/mol.

7. The welding method according to claim 1, wherein the polyester polymer is a copolyester polymer.

8. The welding method according to claim 1, wherein the polyester polymer is derived from at least one acid selected from terephthalic acid and isophthalic acid as an acid component, and at least one alcohol component selected from the group consisting of 3-hydroxy-2,2-dimethylpropyl-3-hydroxy-2,2-dimethylpropanoate (HPHP), ethylene glycol, diethylene glycol, neopentyl glycol, cyclohexanedimethanol, 1,3-propanediol, 1,4-butanediol and 2-methyl-1,3-propanediol.

9. The welding method according to claim 1, wherein the polyester polyol has a weight-average molecular weight between 1,500 and 100,000 g/mol.

10. The welding method according to claim 1, wherein the polyester polymer is hydroxyl-group-terminated.

11. An object comprising a polyolefin plastic material welded to a second plastic material by the welding method according to claim 1.

12. A polyolefin plastic material welded to a second plastic material selected from the group consisting of polycarbonate (PC), methyl methacrylate acrylonitrile butadiene styrene (MABS), acrylonitrile butadiene styrene (ABS), polymethyl methacrylate (PMMA), polyethylene terephthalate (PET), polybutylene terephthalate (PBT), polystyrene (PS), polystyrene acrylonitrile (SAN), polyacrylic ester styrene acrylonitrile (ASA), polyamide (PA), and high impact polystyrene (HIPS) by the welding method according to claim 1.
